(19) United States
(12) Patent Application Publication
(10) Pub. No.: US 2024/0418638 A1
(43) Pub. Date: Dec. 19, 2024

(54) MACHINE LEARNING DEVICE, EXHAUST GAS ANALYSIS DEVICE, MACHINE LEARNING METHOD, EXHAUST GAS ANALYSIS METHOD, MACHINE LEARNING PROGRAM, AND EXHAUST GAS ANALYSIS PROGRAM

(71) Applicant: HORIBA, LTD., Kyoto-shi, Kyoto (JP)

(72) Inventors: Makoto NAGAOKA, Kyoto-shi, Kyoto (JP); Takashi SAITO, Kyoto-shi, Kyoto (JP)

(73) Assignee: HORIBA, LTD., Kyoto-shi, Kyoto (JP)

(21) Appl. No.: 18/717,865

(22) PCT Filed: Oct. 26, 2022
(86) PCT No.: PCT/JP2022/039964

§ 371 Date: Jun. 7, 2024

(30) Foreign Application Priority Data
Dec. 28, 2021 (JP) 2021-213871

(51) Int. Cl. G01N 21/3504; G01N 21/35; G06N 20/00

(52) U.S. Cl. CPC G01N 21/3504; G06N 20/00; G01N 2021/3595; G01N 2201/0216

(57) ABSTRACT

A machine learning device used in an exhaust gas analysis device that irradiates combustion exhaust gas with light, performs a detection of light transmitted through the combustion exhaust gas, and analyzes the combustion exhaust gas based on a detection signal includes a training data reception unit that receives training data including a reference value of a specific component concentration and at least one of spectrum data obtained by irradiating the combustion exhaust gas with light or an individual component concentration selected based on an element balance formula for determining the specific component concentration, or an arithmetic value of a specific component concentration calculated using the individual component concentration in the element balance formula, and a machine learning unit that performs machine learning on a relationship between the reference value and at least one of the spectrum data, the individual component concentration, or the arithmetic value using the training data.

### TECHNICAL FIELD

The present invention relates to a machine learning device, an exhaust gas analysis device, a machine learning method, an exhaust gas analysis method, a machine learning program, and an exhaust gas analysis program.

### BACKGROUND ART

Conventionally, as disclosed in Patent Literature 1, an FTIR analyzer using Fourier transform infrared spectroscopy (FTIR) is used to analyze components contained in exhaust gas. With this FTIR analyzer, it is possible to simultaneously analyze multiple components such as CO, CO₂, NO, H₂O, NO₂, C₂H₅OH, HCHO, or CH₄ in the exhaust gas.

However, in the FTIR analyzer, a component that absorbs infrared rays can be analyzed, but a component that does not absorb infrared rays cannot be analyzed. Therefore, in the case of measuring the concentration of H₂ that does not absorb infrared rays, a dedicated H₂ analyzer such as a thermal conductive gas analyzer (TCD) is required separately from the FTIR analyzer. Furthermore, in a case where the concentration of O₂ that does not absorb infrared rays is measured, a dedicated O₂ analyzer such as a zirconia sensor is required separately from the FTIR analyzer. As a result, an installation space for both the FTIR analyzer and the H₂ analyzer or the O₂ analyzer is required, and the exhaust gas analysis device is increased in size. Such a problem may occur not only in the FTIR analyzer but also in other exhaust gas analysis devices using light.

### CITATION LIST

### Patent Literature

Patent Literature 1: JP 2000-346801 A

### SUMMARY OF INVENTION

### Technical Problem

Therefore, the present invention has been made in view of the above-described problems, and a main object thereof is to enable measurement of the H₂ concentration or the O₂ concentration that needs to be measured using another analyzer in the exhaust gas analysis device.

### Solution to Problem

That is, a machine learning device according to the present invention is a machine learning device used in an exhaust gas analysis device that irradiates a combustion exhaust gas with light, performs a detection of light transmitted through the combustion exhaust gas, and analyzes the combustion exhaust gas based on a detection signal of the detection, the machine learning device including: a training data reception unit that receives training data; and a machine learning unit that performs machine learning using the training data, in which the training data reception unit receives training data including: a reference value of a specific component concentration that is at least one of an H₂ concentration or an O₂ concentration obtained by an analyzer different from the exhaust gas analysis device; and at least one of spectrum data obtained by irradiating the combustion exhaust gas with light, an individual component concentration selected based on an element balance formula for determining the specific component concentration, or an arithmetic value of a specific component concentration calculated using the individual component concentration in the element balance formula, and the machine learning unit performs machine learning on a relationship between a reference value of the specific component concentration, and at least one of the spectrum data, the individual component concentration, or the arithmetic value of the specific component concentration to generate specific component correlation data.

With such a configuration, by performing machine learning on a relationship between a reference value of the specific component concentration that is at least one of the H₂ concentration or the O₂ concentration, and at least one of the spectrum data obtained by irradiating the combustion exhaust gas with light, the individual component concentration selected based on the element balance formula for determining the specific component concentration, or the arithmetic value of the specific component concentration calculated using the individual component concentration in the element balance formula, it is possible to calculate the specific component concentration from at least one of the spectrum data obtained by irradiating the combustion exhaust gas with light, the individual component concentration obtained by the exhaust gas analysis device, or the arithmetic value of the specific component concentration calculated from the individual component concentration and the element balance formula, using a machine learning model generated by the machine learning. As a result, the H₂ concentration or the O₂ concentration that needs to be measured using another analyzer in the exhaust gas analysis device can be measured. In particular, in exhaust gas analysis using infrared light, the H₂ concentration or the O₂ concentration that does not absorb infrared light can be measured.

Furthermore, in the machine learning device of the present invention, it is preferable that the training data reception unit receives training data including the reference value of the specific component concentration and the spectrum data, and the machine learning unit performs machine learning on a relationship between the reference value of the specific component concentration and the spectrum data to generate the specific component correlation data.

Moreover, in order to enable accurate measurement of the H₂ concentration or the O₂ concentration, it is desirable that the training data reception unit further receive the individual component concentration as training data, and the machine learning unit perform machine learning on a relationship among the reference value of the specific component concentration, the spectrum data, and the individual component concentration to generate the specific component correlation data.

As a specific embodiment of the machine learning using the reference value of the specific component concentration, the arithmetic value of the specific component concentration, and the spectrum data, it is desirable that the machine learning unit include: a first correlation data generation unit that calculates a minimum error value obtained by minimizing an error between the reference value of the specific component concentration and the arithmetic value of the specific component concentration, and generates, as a part of the specific component correlation data, first correlation data indicating a correlation between the minimum error value and a parameter used to calculate the minimum error value; and a second correlation data generation unit that performs machine learning on a relationship between the spectrum data and the minimum error value to generate, as a part of the specific component correlation data, second correlation data indicating a correlation between the spectrum data and the minimum error value.

Furthermore, in the machine learning device of the present invention, it is preferable that the training data reception unit receives training data including the reference value of the specific component concentration and the individual component concentration, and the machine learning unit performs machine learning on a relationship between the reference value of the specific component concentration and the individual component concentration to generate the specific component correlation data.

In a case where machine learning is performed on H₂ correlation data as the specific component correlation data, it is conceivable that the individual component concentration is at least one of a CO₂ concentration, a CO concentration, an H₂O concentration, or a THC concentration. Furthermore, in a case where machine learning is performed on O₂ correlation data as the specific component correlation data, it is conceivable that the individual component concentration is at least one of a CO₂ concentration, a CO concentration, an H₂O concentration, a THC concentration, or an NO concentration.

Furthermore, in the case of measuring total hydrocarbons (THC) by the conventional exhaust gas analysis device, two-stage calculation is performed in which the concentrations of hydrocarbons (HC) are individually obtained from the spectrum data, and then, the concentrations are weighted and added up, and an error that can occur in the setting of a weighting coefficient is superimposed on an error that can occur in the concentration measurement of each HC. Therefore, it is difficult to improve the measurement accuracy.

In order to improve the measurement accuracy of the THC concentration in the exhaust gas analysis device, it is desirable that the training data reception unit receive training data including a reference value of a THC concentration obtained by an analyzer different from the exhaust gas analysis device and the spectrum data, and the machine learning unit perform machine learning on a relationship between the reference value of the THC concentration and the spectrum data to generate THC correlation data.

Here, it is desirable that the individual component concentration include a THC concentration, and the THC concentration be obtained from spectrum data obtained by the exhaust gas analysis device and the THC correlation data.

Furthermore, an exhaust gas analysis device according to the present invention is an exhaust gas analysis device that analyzes combustion exhaust gas, the exhaust gas analysis device including: a light source that irradiates the combustion exhaust gas with light; a photodetector that detects light transmitted through the combustion exhaust gas; a specific component correlation data storage unit that stores specific component correlation data obtained by learning a relationship between a specific component concentration that is at least one of an H₂ concentration or an O₂ concentration in the combustion exhaust gas and at least one of spectrum data obtained by irradiating the combustion exhaust gas with light, an individual component concentration selected on the basis of an element balance formula for determining the specific component concentration, or an arithmetic value of the specific component concentration calculated using the individual component concentration in the element balance formula; and a specific component concentration calculation unit that calculates a specific component concentration in the combustion exhaust gas from at least one of the spectrum data, the individual component concentration, or the arithmetic value of the specific component concentration, and the specific component correlation data.

With such a configuration, the specific component concentration can be calculated from at least one of the spectrum data obtained by irradiating the combustion exhaust gas with light, the individual component concentration obtained by the exhaust gas analysis device, or the arithmetic value of the specific component concentration calculated from the individual component concentration and the element balance formula by using the specific component correlation data (machine learning model) obtained by learning the relationship between the specific component concentration that is at least one of the H₂ concentration or the O₂ concentration in the combustion exhaust gas and at least one of the spectrum data obtained by irradiating the combustion exhaust gas with light, the individual component concentration selected on the basis of the element balance formula for determining the specific component concentration, or the arithmetic value of the specific component concentration calculated using the individual component concentration in the element balance formula. As a result, the H₂ concentration or the O₂ concentration that needs to be measured using another analyzer in the analysis device can be measured. In particular, in exhaust gas analysis using infrared light, the H₂ concentration or the O₂ concentration that does not absorb infrared light can be measured.

Furthermore, the exhaust gas analysis device of the present invention desirably further includes: a THC correlation data storage unit that stores THC correlation data obtained by learning a relationship between a reference value of a THC concentration obtained by an analyzer different from the exhaust gas analysis device and the spectrum data; and a THC concentration calculation unit that calculates a THC concentration in the combustion exhaust gas from spectrum data obtained by irradiating the combustion exhaust gas with light and the THC correlation data. With this configuration, the THC concentration in the combustion exhaust gas can be accurately measured.

Furthermore, desirably, the individual component concentration includes a THC concentration, and the THC concentration is calculated by the THC concentration calculation unit. With this configuration, in a case where the H₂ concentration or the O₂ concentration is measured using the THC concentration, the H₂ concentration or the O₂ concentration can be accurately measured.

As a specific aspect of measuring the H₂ concentration or the O₂ concentration using the reference value of the specific component concentration, the arithmetic value of the specific component concentration, and the spectrum data, it is desirable that a trained model storage unit include: a first correlation data storage unit that stores first correlation data indicating a correlation between a minimum error value between the reference value of the specific component concentration and the arithmetic value of the specific component concentration and a parameter used to calculate the minimum error value; a second correlation data storage unit that stores second correlation data indicating a correlation between the spectrum data and the minimum error value; and the specific component concentration calculation unit include a minimum error value calculation unit that calculates the minimum error value from the spectrum data and the second correlation data, and calculate the specific component concentration in the combustion exhaust gas from the minimum error value obtained by the minimum error value calculation unit and the first correlation data.

As a specific aspect in which the effect of the present invention is remarkably exhibited, it is possible to exemplify a case in which the combustion exhaust gas is an exhaust gas of an automobile, and it is preferable that the exhaust gas analysis device is of a so-called FTIR system using Fourier transform infrared spectroscopy.

Moreover, a machine learning method according to the present invention is a machine learning method used in an exhaust gas analysis device that irradiates a combustion exhaust gas with light, performs a detection of light transmitted through the combustion exhaust gas, and analyzes the combustion exhaust gas based on a detection signal of the detection, the machine learning method including: a training data reception step of receiving training data; and a machine learning step of performing machine learning using the training data, in which the training data reception step receives training data including: a reference value of a specific component concentration that is at least one of an H₂ concentration or an O₂ concentration obtained by an analyzer different from the exhaust gas analysis device; and at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, and the machine learning step performs machine learning on a relationship between a reference value of the specific component concentration, and at least one of the spectrum data, the individual component concentration, or the arithmetic value of the specific component concentration to generate specific component correlation data.

In addition, a machine learning program according to the present invention is a machine learning program used in an exhaust gas analysis device that irradiates a combustion exhaust gas with light, performs a detection of light transmitted through the combustion exhaust gas, and analyzes the combustion exhaust gas based on a detection signal of the detection, the machine learning program causing a computer to have: a function as a training data reception unit that receives training data; and a function as a machine learning unit that performs machine learning using the training data, in which the training data reception unit receives training data including: a reference value of a specific component concentration that is at least one of an H₂ concentration or an O₂ concentration obtained by an analyzer different from the exhaust gas analysis device; and at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, and the machine learning unit performs machine learning on a relationship between a reference value of the specific component concentration, and at least one of the spectrum data, the individual component concentration, or the arithmetic value of the specific component concentration to generate specific component correlation data.

In addition, an exhaust gas analysis method according to the present invention is An exhaust gas analysis method of analyzing a combustion exhaust gas using a light source that irradiates the combustion exhaust gas with light and a photodetector that detects light transmitted through the combustion exhaust gas, the exhaust gas analysis method including, by using specific component correlation data obtained by learning a relationship between a specific component concentration that is at least one of an H₂ concentration or an O₂ concentration in the combustion exhaust gas, and at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, calculating a specific component concentration in the combustion exhaust gas from at least one of the spectrum data, the individual component concentration, or the arithmetic value of the specific component concentration, and the specific component correlation data.

Moreover, in addition, an exhaust gas analysis program according to the present invention is an exhaust gas analysis program used in an exhaust gas analysis device using a light source that irradiates combustion exhaust gas with light and a photodetector that detects light transmitted through the combustion exhaust gas, the exhaust gas analysis program causing a computer to have: a function as a specific component correlation data storage unit that stores specific component correlation data obtained by learning a relationship between a specific component concentration that is at least one of an H₂ concentration or an O₂ concentration in the combustion exhaust gas, and at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula; and a function as a specific component concentration calculation unit that calculates a specific component concentration in the combustion exhaust gas from at least one of the spectrum data, the individual component concentration, or the arithmetic value of the specific component concentration, and the specific component correlation data.

### Advantageous Effects of Invention

According to the present invention described above, it is possible to measure the H₂ concentration or the O₂ concentration that needs to be measured using another analyzer in the exhaust gas analysis device.

### BRIEF DESCRIPTION OF DRAWINGS

FIG. 1 is an overall view of an exhaust gas measurement system including an exhaust gas analysis device according to an embodiment of the present invention.

FIG. 2 is a schematic diagram illustrating the entire exhaust gas analysis device according to the embodiment.

FIG. 3 is a basic functional block diagram of an arithmetic processing device according to the embodiment.

FIG. 4 is a functional block diagram of a machine learning device according to the embodiment.

FIG. 5 is a functional block diagram of an arithmetic processing device according to the embodiment.

FIG. 6 is a functional block diagram of a machine learning device according to a modified embodiment.

FIG. 7 is a functional block diagram of a machine learning device according to a modified embodiment.

FIG. 8 is a functional block diagram of an arithmetic processing device according to a modified embodiment.

FIG. 9 is a functional block diagram of a machine learning device according to a modified embodiment.

FIG. 10 is a functional block diagram of an arithmetic processing device according to a modified embodiment.

FIG. 11 is a functional block diagram of an arithmetic processing device according to a modified embodiment.

FIG. 12 is a functional block diagram of a machine learning device according to a modified embodiment.

### DESCRIPTION OF EMBODIMENTS

Hereinafter, an exhaust gas analysis device according to an embodiment of the present invention will be described with reference to the drawings. Note that any of the drawings illustrated below is schematically illustrated by omitting or exaggerating as appropriate for easy understanding. The same components are denoted by the same reference signs, and the description thereof will be omitted as appropriate.

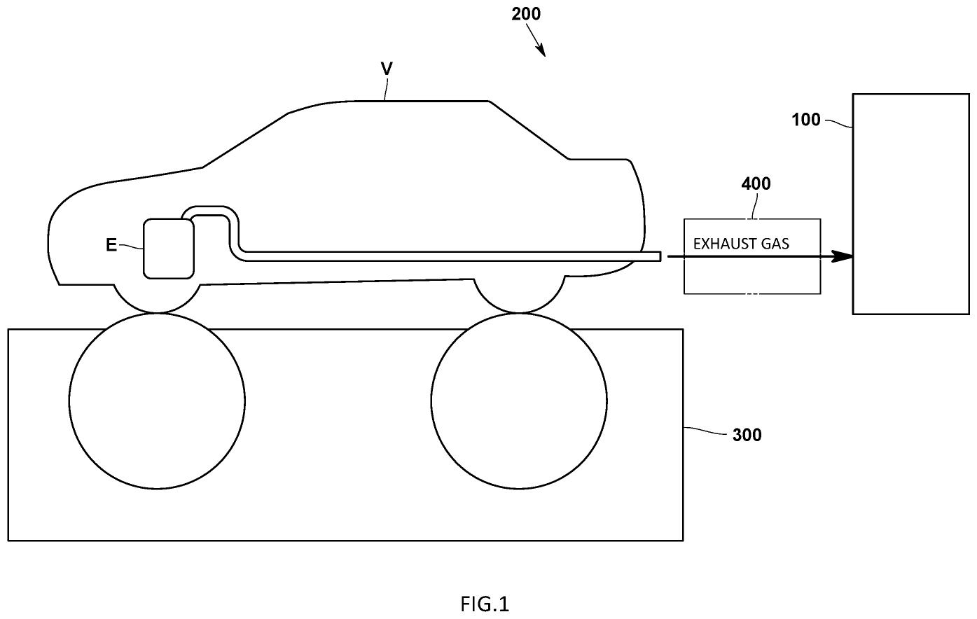

An exhaust gas analysis device 100 of the present embodiment constitutes, for example, a part of an exhaust gas measurement system 200. As illustrated in FIG. 1, the exhaust gas measurement system 200 includes a chassis dynamometer 300, an exhaust gas sampling device 400 that samples a combustion exhaust gas (Hereinafter, it is simply referred to as “exhaust gas”.) of an automobile V which is a test piece traveling on the chassis dynamometer 300, and the analysis device 100 that analyzes a measurement target component in the sampled exhaust gas.

### <Basic Configuration of Exhaust Gas Analysis Device 100>

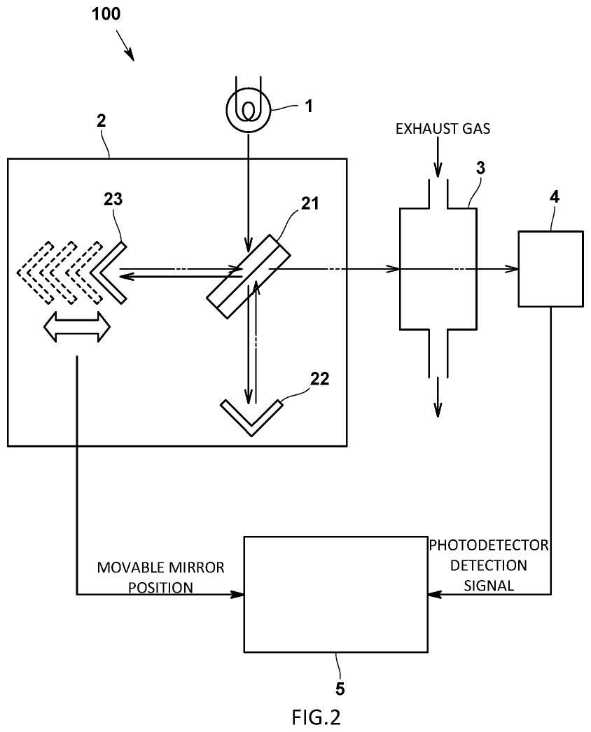

Specifically, as illustrated in FIG. 2, the exhaust gas analysis device 100 is an infrared gas analyzer using Fourier transform infrared spectroscopy (FTIR) including an infrared light source 1, an interferometer (spectroscopic unit) 2, a measurement cell 3, a photodetector 4, an arithmetic processing device 5, and the like.

The infrared light source 1 emits infrared light having a broad spectrum (continuous light including light of a large number of wave numbers), and for example, a tungsten-iodine lamp or a high-luminance ceramic light source is used.

As illustrated in the drawing, the interferometer 2 uses a so-called Michelson interferometer including one half mirror (beam splitter) 21, a fixed mirror 22, and a movable mirror 23. The light from the infrared light source 1 incident on the interferometer 2 is divided into reflected light and transmitted light by the half mirror 21. One piece of light is reflected by the fixed mirror 22, the other is reflected by the movable mirror 23, returns to the half mirror 21 again, is combined, and is emitted from the interferometer 2.

The measurement cell 3 is a transparent cell into which the sampled exhaust gas is introduced, and light emitted from the interferometer 2 is transmitted through the exhaust gas in the measurement cell 3 and guided to the photodetector 4.

The photodetector 4 detects the infrared light transmitted through the exhaust gas and outputs a detection signal (light intensity signal) thereof to the arithmetic processing device 5. The photodetector 4 of the present embodiment is, for example, an MCT (HgCdTe) detector, but may be a photodetector including other infrared detection elements.

The arithmetic processing device 5 includes, for example, an analog electric circuit including a buffer, an amplifier, and the like, a digital electric circuit including a CPU, a memory, a DSP, or the like, and an A/D converter interposed therebetween.

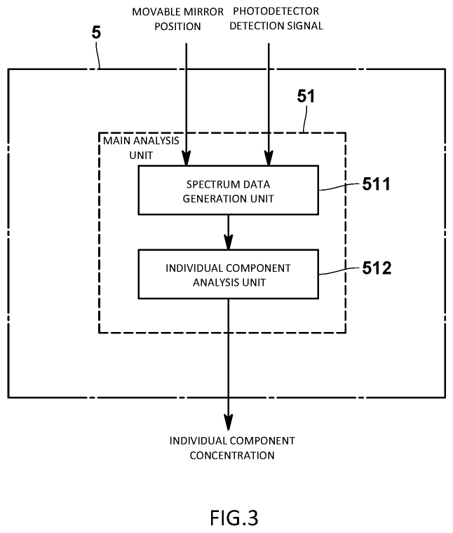

The arithmetic processing device 5 exerts a function as a main analysis unit 51 as illustrated in FIG. 3 by cooperation of the CPU and its peripheral devices according to a predetermined program stored in the memory.

The main analysis unit 51 calculates transmitted light spectrum data indicating a spectrum of light transmitted through the exhaust gas from the detection signal (light intensity signal) of the photodetector 4, calculates infrared absorption spectrum data from the transmitted light spectrum data, specifies various components in the exhaust gas, and calculates a concentration of each component.

The main analysis unit 51 includes a spectrum data generation unit 511 and an individual component analysis unit 512.

When the movable mirror 23 is moved forward and backward and a light intensity transmitted through the exhaust gas is observed with a position of the movable mirror 23 as a horizontal axis, in the case of light of a single wave number, the light intensity draws a sine curve by interference. On the other hand, since the actual light transmitted through the exhaust gas is continuous light, the sine curve differs for each wave number, the actual light intensity is superposition of the sine curves drawn by the respective wave numbers, and the interference pattern (interferogram) is in the form of a wave bundle.

The spectrum data generation unit 511 obtains the position of the movable mirror 23 by using a distance meter (not illustrated) such as a HeNe laser (not illustrated), obtains the light intensity at each position of the movable mirror 23 by using the photodetector 4, and performs fast Fourier transform (FFT) on the interference pattern obtained from these, thereby converting each wave number component into transmitted light spectrum data with the horizontal axis. Then, for example, the transmitted light spectrum data of the exhaust gas is further converted into the absorption spectrum data based on the transmitted light spectrum data measured in advance in a state where the measurement cell 3 is empty.

The individual component analysis unit 512 specifies various components (for example, CO, CO₂, NO, H₂O, NO₂, a hydrocarbon component (HC), or the like) contained in the exhaust gas from, for example, each peak position (wave number) of the absorption spectrum data and a height thereof, calculates a concentration of each component, and outputs the concentration as individual component concentration data.

### <Machine Learning Device 6>

Next, a machine learning device 6 for enabling measurement of the H₂ concentration or the O₂ concentration in the exhaust gas using the exhaust gas analysis device 100 will be described.

The machine learning device 6 of the present embodiment performs machine learning by utilizing the fact that the H₂ concentration and the O₂ concentration can be estimated using an element balance formula obtained from a fuel combustion formula described below. From the following element balance formula (conservation law of substance amount), the H₂ concentration can be linearly regressed by the concentrations of the components (CO₂, CO, H₂O, THC), and the O₂ concentration can be linearly regressed by the concentrations of the components (CO₂, CO, H₂O, THC, NO). Furthermore, since the H₂ concentration and the O₂ concentration can be estimated from individual component concentrations, the H₂ concentration and the O₂ concentration can also be estimated from spectrum data for obtaining the individual component concentrations.

Here, as the individual component concentration in the case of calculating the H₂ concentration, at least one of a CO₂ concentration, a CO concentration, an H₂O concentration, or a THC concentration can be used. Furthermore, as the individual component concentration in the case of calculating the O₂ concentration, at least one of a CO₂ concentration, a CO concentration, an H₂O concentration, a THC concentration, or an NO concentration can be used.

(Fuel combustion formula)

CₐH_{b}O_{c}+dO₂+eN₂+fCO₂+gH₂O→n₁CO₂+n₂CO+n₃H₂O+n₄H₂+n₅ O₂+n₆NO+n₇N₂+n₈C_{a′}H_{b′}+r

In the above formula, the total hydrocarbon (THC) is represented by C_{a′}H_{b′}, and a′ and b′ are averages of the number of C and the number of H of each hydrocarbon.

Since r is another component and is a trace amount as compared with other components, it can be ignored in the calculation of the H₂ concentration and the O₂ concentration.

(Element balance formula)

C: a+f=n₁+n₂+a′n₈

H: b+2g=2n₃+2n₄+b′n₈

O: c+2d+2f+g=2n₁+n₂+n₃+2n₅+n₆

N: 2e=n₆+2n₇

n₀: Total amount of substances in combustion exhaust gas n₀=n₁+n₂+n₃+n₄+n₅+n₆+n₇+n₈

xₖ: Molar fraction of component k (xₖ=nₖ/n₀)(k=1 to 8)

k=1; CO₂, 2; CO, 3; H₂O, 4; H₂, 5; O₂, 6; NO, 7; N₂, 8; THC (C_{a′}H_{b′})

a′n₈=n₀x_{THC} and handled in units of x_{THC}/ppmC.

uk: Mole fraction of intake air component j excluding fuel (uⱼ=j/(d+e+f+g)) j=d; O₂, e; N₂, f; CO₂, g; H₂O

nᵣ: Total molar ratio of intake air and exhaust air excluding fuel nᵣ=(d+e+f+g)/n₀

Then, the following relational formula is obtained from the element balance formula of C.

$$[ Mathematical Formula 1 ]$$

$$\frac{a}{{n}_{o}} = {x}_{CO 2} + {x}_{CO} + {x}_{THC} - \frac{f}{{n}_{o}} = {x}_{CO 2} + {x}_{CO} + {x}_{THC} - {n}_{r} {u}_{CO 2}$$

Furthermore, the following relational formula is obtained from the element balance formula between C and H.

$$[ Mathematical Formula 2 ]$$

$$\frac{b}{a} = \frac{{u}_{H 2 O} {x}_{CO} + 2 ( {x}_{H 2 O} - {u}_{H 2 O} ) + ( 2 + {u}_{H 2 O} ) {x}_{H 2} + [ \frac{{b}^{′}}{{a}^{′}} + \frac{4 - {b}^{′}}{2 {a}^{′}} {u}_{H 2 O} ] {x}_{THC}}{( 1 - \frac{{u}_{H 2 O}}{2} ) ( {x}_{CO 2} + {x}_{CO} + {x}_{THC} - {n}_{r} {u}_{CO 2} )}$$

From the above formula, the following formula of H₂ concentration is obtained. Note that, since the formula becomes complicated, CO₂ in the intake air is negligible compared to other components in the following formula (u_{CO2}=0).

$$[ Mathematical Formula 3 ]$$

$${x}_{H 2} = \frac{\frac{b}{a} - ( \frac{b}{a} + 2 ) {u}_{H 2 O} / 2}{1 + {u}_{H 2 O} / 2} \frac{{x}_{CO}}{2} + \frac{\frac{b}{a} ( 1 - {u}_{H 2 O} / 2 )}{1 + {u}_{H 2 O} / 2} \frac{{x}_{CO 2}}{2} + \frac{( \frac{b}{a} - \frac{b '}{{a}^{′}} ) - ( \frac{4}{{a}^{′}} + \frac{b}{a} - \frac{{b}^{′}}{{a}^{′}} ) {u}_{H 2 O} / 2}{1 + ι {ι}_{H 2 O} / 2} \frac{{x}_{THC}}{2} - \frac{1}{1 + {u}_{H 2 O} / 2} ( {x}_{H 2 O} - {u}_{H 2 O} ) = {w}_{1} {x}_{CO} + {w}_{2} {x}_{CO 2} + {w}_{3} {x}_{THC} - {w}_{4} ( {x}_{H 2 O} - {u}_{H 2 O} )$$

Thus, the H₂ concentration can be linearly regressed by the concentrations of the components (CO₂, CO, H₂O, THC).

On the other hand, the following relational formula is obtained from the element balance formula of O and N. Note that, since the formula becomes complicated, in the following description, O is not contained in the fuel, and CO₂ and H₂O in the intake air are negligible compared to other components.

$$[ Mathematical Formula 4 ]$$

$$\frac{2 {x}_{{CO}_{2}} + {x}_{CO} + {x}_{{H}_{2} O} + 2 {x}_{{O}_{2}} + {x}_{NO}}{2 {x}_{{N}_{2}} + {x}_{NO}} = \frac{2 {x}_{{CO}_{2}} + {x}_{CO} + {x}_{{H}_{2} O} + 2 {x}_{{O}_{2}} + {x}_{NO}}{2 [ 1 - ( {x}_{{CO}_{2}} + {x}_{CO} + {x}_{{H}_{2} O} + {x}_{{H}_{2}} + {x}_{{O}_{2}} + {x}_{HC} + {x}_{NO} ) ] + {x}_{NO}} = \frac{1}{A}$$

Since a ratio of a substance amount of 0 to a substance amount of N in the dry air is constant, the above is a constant value (constant A). As a result, the following formula is obtained.

$$[ Mathematical Formula 5 ]$$

$${x}_{{O}_{2}} = \frac{1 - [ \begin{matrix}( 1 + \frac{A}{2} ) {x}_{CO} + ( 1 + A ) {x}_{{CO}_{2}} + \\ ( 1 + \frac{A}{2} ) {x}_{{H}_{2} O} + {x}_{{H}_{2}} + {x}_{THC} / {a}^{′} + \frac{1}{2} ( 1 + A ) {x}_{NO}\end{matrix} ]}{1 + A}$$

When the H₂ term of the above formula is eliminated in the above-described H₂ concentration formula (H/C element balance), the following O₂ concentration formula is obtained.

$$[ Mathematical Formula 6 ]$$

$${x}_{{O}_{2}} = \frac{1 - [ \begin{matrix}( 1 + \frac{b}{2 a} + \frac{A}{2} ) {x}_{CO} + ( 1 + \frac{b}{2 a} + A ) {x}_{{CO}_{2}} + \\ ( \frac{b}{2 a} - \frac{{b}^{′}}{2 {a}^{′}} + \frac{1}{{a}^{′}} ) {x}_{THC} + \frac{A}{2} {x}_{{H}_{2} O} + \frac{1}{2} ( 1 + A ) {x}_{NO}\end{matrix} ]}{1 + A} = {w}_{0} + {w}_{1} {x}_{CO} + {w}_{2} {x}_{CO 2} + {w}_{3} {x}_{THC} + {w}_{4} {x}_{H 2 O} + {w}_{5} {x}_{NO}$$

Thus, the O₂ concentration can be linearly regressed by the concentrations of the components (CO₂, CO, H₂O, THC, NO).

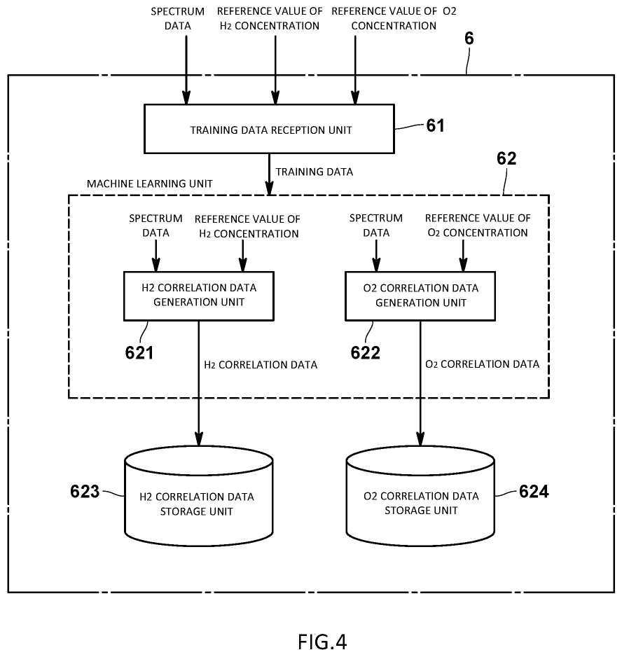

The machine learning device 6 is a computer including a CPU, a memory, an input/output interface, an AD converter, or an input means such as a keyboard, and functions as a training data reception unit 61 that receives training data, a machine learning unit 62 that performs machine learning using the training data, and the like as illustrated in FIG. 4 by cooperation of the CPU and its peripheral devices in accordance with a machine learning program stored in the memory. Note that the machine learning device 6 may be incorporated in the arithmetic processing device 5 of the exhaust gas analysis device 100 described above, or the arithmetic processing device 5 may be provided with some functions of the machine learning device 6.

The training data reception unit 61 receives training data including a reference value of the H₂ concentration obtained by an H₂ analyzer (not illustrated) different from the infrared gas analyzer (exhaust gas analysis device), a reference value of the O₂ concentration obtained by an O₂ analyzer (not illustrated) different from the infrared gas analyzer (exhaust gas analysis device), and spectrum data obtained by the infrared gas analyzer. The spectrum data included in the training data is the absorption spectrum data generated by the spectrum data generation unit 511 of the arithmetic processing device 5, but may be transmitted light spectrum data of the exhaust gas. As the H₂ analyzer, for example, a thermal conductive gas analyzer (TCD), a mass spectrometer, or the like may be used. Furthermore, as the O₂ analyzer, for example, a zirconia type sensor, a magnetic oxygen concentration meter, or the like may be used.

The machine learning unit 62 includes an H₂ correlation data generation unit 621 that performs machine learning on a relationship between the reference value of the H₂ concentration and the spectrum data to generate H₂ correlation data (machine learning model for H₂ concentration calculation) indicating a correlation between the H₂ concentration and the spectrum data, and an O₂ correlation data generation unit 622 that performs machine learning on a relationship between the reference value of the O₂ concentration and the spectrum data to generate O₂ correlation data (machine learning model for O₂ concentration calculation) indicating a correlation between the O₂ concentration and the spectrum data.

Here, the H₂ correlation data (machine learning model for H₂ concentration calculation) calculated by the H₂ correlation data generation unit 621 is stored in an H₂ correlation data storage unit 623, and the O₂ correlation data (machine learning model for O₂ concentration calculation) calculated by the O₂ correlation data generation unit 622 is stored in an O₂ correlation data storage unit 624.

<Characteristic Configuration of Exhaust Gas Analysis Device 100 (Measurement of H₂Concentration or O₂ Concentration)>

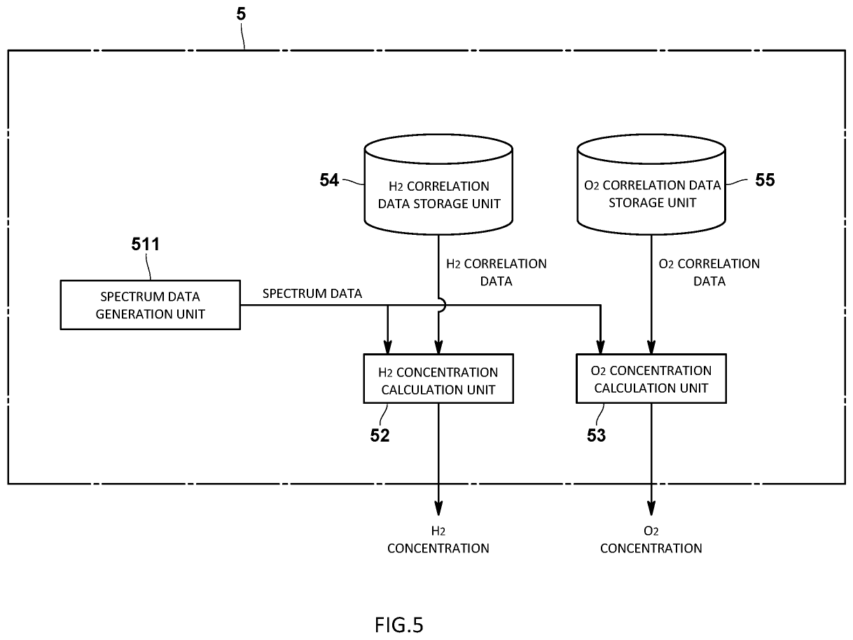

As illustrated in FIG. 5, the exhaust gas analysis device 100 can calculate the H₂ concentration using the H₂ correlation data (machine learning model for H₂ concentration calculation) generated by the machine learning device 6, and can calculate the O₂ concentration using the O₂ correlation data (machine learning model for O₂ concentration calculation).

Specifically, the arithmetic processing device 5 of the exhaust gas analysis device 100 includes an H₂ concentration calculation unit 52 that calculates the H₂ concentration using the H₂ correlation data, and an O₂ concentration calculation unit 53 that calculates the O₂ concentration using the O₂ correlation data. Note that the H₂ correlation data is stored in an H₂ correlation data storage unit 54, and the O₂ correlation data is stored in an O₂ correlation data storage unit 55.

Note that in a case where a part or all of the machine learning device 6 is incorporated into the arithmetic processing device 5, the H₂ correlation data storage unit 54 may be configured from the H₂ correlation data storage unit 623 of the machine learning device 6, or the O₂ correlation data storage unit 55 may be configured from the O₂ correlation data storage unit 624 of the machine learning device 6.

The H₂ concentration calculation unit 52 calculates the H₂ concentration in the exhaust gas from the spectrum data generated by the spectrum data generation unit 511 and the H₂ correlation data.

Here, in a case where the H₂ correlation data is generated using the absorption spectrum data, the H₂ concentration calculation unit 52 calculates the H₂ concentration using the absorption spectrum data generated by the spectrum data generation unit 511. Furthermore, in a case where the H₂ correlation data is generated using the transmitted light spectrum data, the H₂ concentration calculation unit 52 calculates the H₂ concentration using the transmitted light spectrum data generated by the spectrum data generation unit 511.

The O₂ concentration calculation unit 53 calculates the O₂ concentration in the combustion exhaust gas from the spectrum data generated by the spectrum data generation unit 511 and the O₂ correlation data.

Here, in a case where the O₂ correlation data is generated using the absorption spectrum data, the O₂ concentration calculation unit 53 calculates the O₂ concentration using the absorption spectrum data generated by the spectrum data generation unit 511. Furthermore, in a case where the O₂ correlation data is generated using the transmitted light spectrum data, the O₂ concentration calculation unit 53 calculates the O₂ concentration using the transmitted light spectrum data generated by the spectrum data generation unit 511.

### Effects of Present Embodiment

According to the analysis device 100 of the present embodiment configured as described above, the H₂ concentration or the O₂ concentration can be calculated from the spectrum data obtained from the detection signal of the photodetector 4 using the correlation data (machine learning model) obtained by learning the relationship between the H₂ concentration or the O₂ concentration in the exhaust gas and the spectrum data obtained from the detection signal of the photodetector 4 using the fact that the H₂ concentration and the O₂ concentration can be estimated using the element balance formula. As a result, in the exhaust gas analysis using infrared light, the H₂ concentration or the O₂ concentration that does not absorb infrared light can be measured.

### Modification of First Embodiment

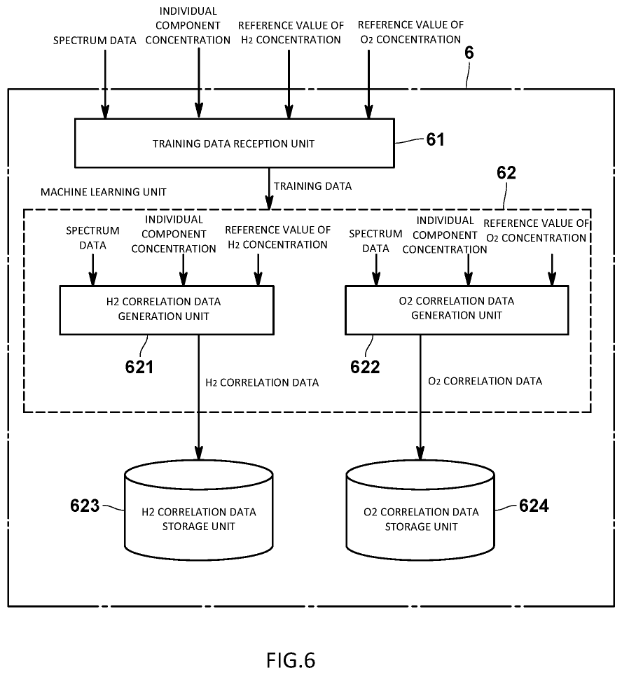

For example, as illustrated in FIG. 6, the training data reception unit 61 may receive, as the training data, the individual component concentration obtained from the spectrum data and selected based on the element balance formula, in addition to the reference value of the H₂ concentration, the reference value of the O₂ concentration, and the spectrum data. Then, in the machine learning unit 62, the H₂ correlation data generation unit 621 performs machine learning on the relationship between the reference value of the H₂ concentration, and the spectrum data and the individual component concentration, and generates H₂ correlation data (machine learning model for H₂ concentration calculation) indicating the correlation between the H₂ concentration, and the spectrum data and the individual component concentration. Furthermore, the O₂ correlation data generation unit 622 performs machine learning on the relationship between the reference value of the O₂ concentration, and the spectrum data and the individual component concentration, and generates O₂ correlation data (machine learning model for O₂ concentration calculation) indicating the correlation between the O₂ concentration, and the spectrum data and the individual component concentration. In this way, by including the individual component concentration selected based on the element balance formula in addition to the spectrum data in the training data, the measurement accuracy of the O₂ concentration or the H₂ concentration can be improved.

### Modified Embodiment 1

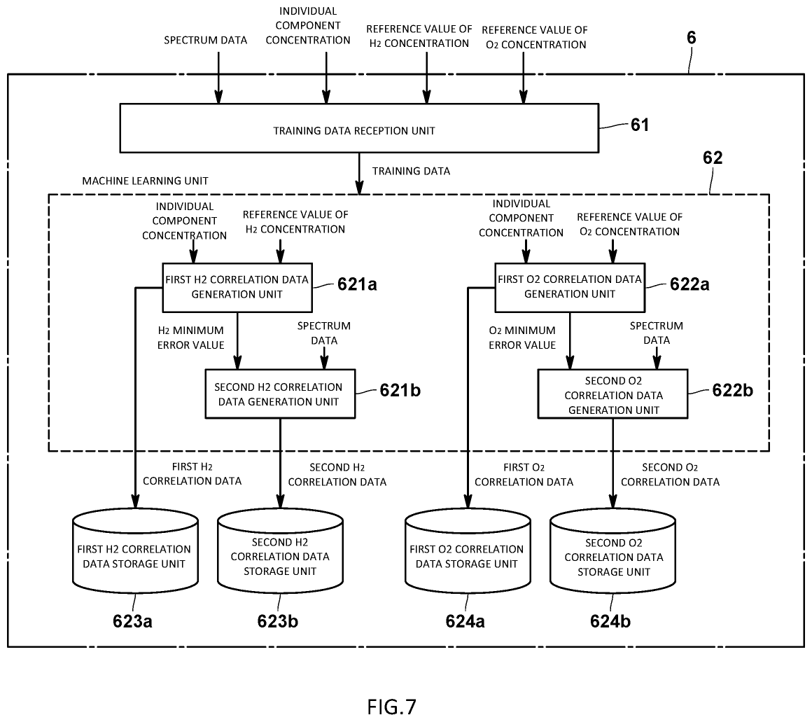

For example, as illustrated in FIG. 7, the training data reception unit 61 receives training data including a reference value of the H₂ concentration obtained by an H₂ analyzer different from the infrared gas analyzer (exhaust gas analysis device), a reference value of the O₂ concentration obtained by an O₂ analyzer different from the infrared gas analyzer (exhaust gas analysis device), spectrum data obtained by the infrared gas analyzer (exhaust gas analysis device), and an individual component concentration obtained from the spectrum data. The spectrum data included in the training data may be transmitted light spectrum data or absorption spectrum data of the exhaust gas generated by the spectrum data generation unit 511.

Here, the individual component concentration is an individual component concentration such as CO, CO₂, NO, H₂O, NO₂, or a hydrocarbon component (HC) analyzed by the individual component analysis unit 512.

Then, the machine learning device 6 of this embodiment estimates an arithmetic value (estimated value) of the H₂ concentration and an arithmetic value (estimated value) of the O₂ concentration using the element balance formula. That is, the fact that the H₂ concentration can be linearly regressed by the concentrations of the components (CO₂, CO, H₂O, THC) and the O₂ concentration can be linearly regressed by the concentrations of the components (CO₂, CO, H₂O, THC, NO) from the above-described element balance formula (conservation law of substance amount) is used.

Note that, in the element balance formula described above, a′ and b′ of the THC concentration are unknown, and there is a considerable error in the measured value of the individual component, and an error also occurs in the calculated value of the element balance formula obtained by simply substituting them. Therefore, in this embodiment, a minimum error value is obtained by minimizing a concentration error between the arithmetic value of the specific component concentration and the reference value by the minimization problem, and the correlation between the minimum error value and the spectrum is calculated.

Specifically, the machine learning unit 62 includes a first H₂ correlation data generation unit 621a that calculates an H₂ minimum error value obtained by minimizing an H₂ concentration error between the reference value of the H₂ concentration and the arithmetic value (estimated value) of the H₂ concentration calculated from the element balance formula, and generates first H₂ correlation data indicating a correlation between the H₂ minimum error value and a parameter used to calculate the H₂ minimum error value, and a second H₂ correlation data generation unit 621b that calculates a relationship between the spectrum data and the H₂ minimum error value, and generates second H₂ correlation data. Here, the parameter used to calculate the H₂ minimum error value in which the H₂ concentration error is minimized is a′ and b′ indicating the THC concentration in the element balance formula. In addition, the H₂ minimum error value may be calculated by calculating the minimization problem by adding a and b, and/or intake moisture of the fuel to the parameter.

Furthermore, the machine learning unit 62 includes: a first O₂ correlation data generation unit 622a that calculates an O₂ minimum error value obtained by minimizing an O₂ concentration error between the reference value of the O₂ concentration and the arithmetic value (estimated value) of the O₂ concentration calculated from the element balance formula, and generates first O₂ correlation data indicating a correlation between the O₂ minimum error value and a parameter used to calculate the O₂ minimum error value; and a second O₂ correlation data generation unit 622b that performs machine learning of a relationship between the spectrum data and the O₂ minimum error value, and generates second O₂ correlation data. Here, the parameter used to calculate the O₂ minimum error value in which the O₂ concentration error is minimized is a′ and b′ of the THC concentration in the element balance formula. In addition, the H₂ minimum error value may be calculated by calculating the minimization problem by adding a and b, and/or intake moisture of the fuel to the parameter.

The first H₂ correlation data generated by the first H₂ correlation data generation unit 621a is data indicating a correlation between the “H₂ minimum error value” and the “parameter of the element balance formula used to calculate the H₂ minimum error value”. Furthermore, the second H₂ correlation data generated by the second H₂ correlation data generation unit 621b is data indicating a correlation between the “spectrum data” and the “H₂ minimum error value”. Here, the first H₂ correlation data is stored in a first H₂ correlation data storage unit 623a, and the second H₂ correlation data is stored in a second H₂ correlation data storage unit 623b.

Furthermore, the first O₂ correlation data generated by the first O₂ correlation data generation unit 622a is data indicating a correlation between the “O₂ minimum error value” and the “parameter of the element balance formula used to calculate the O₂ minimum error value”. Furthermore, the second O₂ correlation data generated by the second O₂ correlation data generation unit 622b is data indicating a correlation between the “spectrum data” and the “O₂ minimum error value”. Here, the first O₂ correlation data is stored in a first O₂ correlation data storage unit 624a, and the second O₂ correlation data is stored in a second O₂ correlation data storage unit 624b.

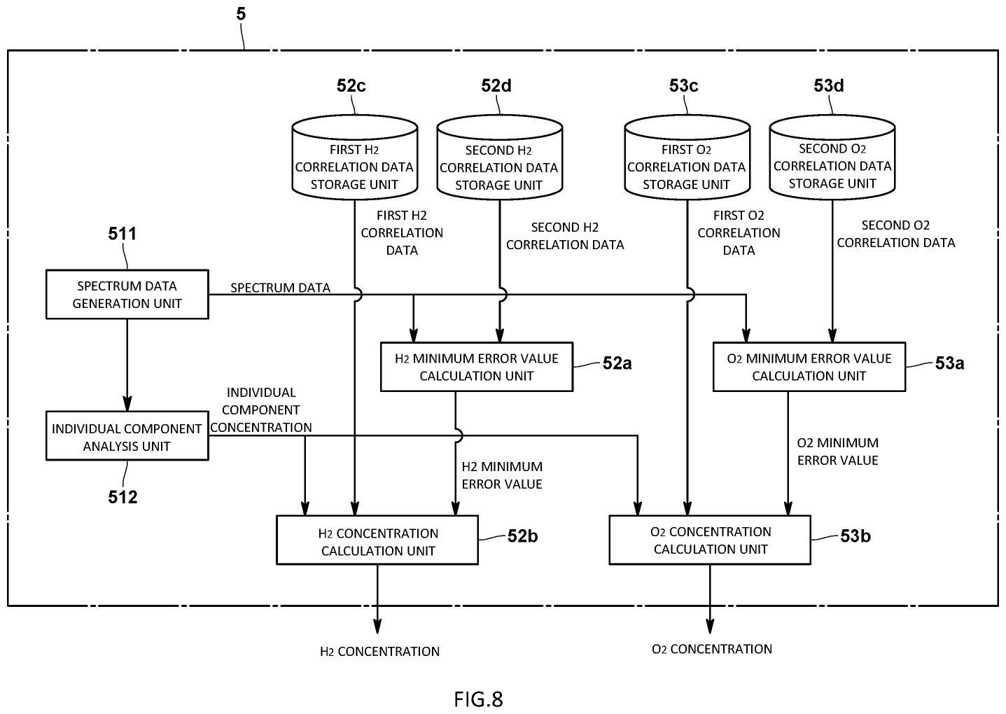

Then, as illustrated in FIG. 8, the exhaust gas analysis device 100 can calculate the H₂ concentration using the first H₂ correlation data and the second H₂ correlation data (machine learning model for H₂ concentration calculation) generated by the machine learning device 6, and can calculate the O₂ concentration using the first O₂ correlation data and the second O₂ correlation data (machine learning model for O₂ concentration calculation).

Specifically, the arithmetic processing device 5 of the exhaust gas analysis device 100 includes an H₂ minimum error value calculation unit 52a that calculates an H₂ minimum error value from the spectrum data and the second H₂ correlation data, and an H₂ concentration calculation unit 52b that calculates the H₂ concentration in the exhaust gas from the H₂ minimum error value obtained by the H₂ minimum error value calculation unit 52a and the first H₂ correlation data. Note that the first H₂ correlation data is stored in a first H₂ correlation data storage unit 52c, and the second H₂ correlation data is stored in a second H₂ correlation data storage unit 52d.

Furthermore, the arithmetic processing device 5 includes an O₂ minimum error value calculation unit 53a that calculates an O₂ minimum error value from the spectrum data and the second O₂ correlation data, and an O₂ concentration calculation unit 53b that calculates an O₂ concentration in the exhaust gas from the O₂ minimum error value obtained by the O₂ minimum error value calculation unit 53a and the first O₂ correlation data. Note that the first O₂ correlation data is stored in a first O₂ correlation data storage unit 53c, and the second O₂ correlation data is stored in a second O₂ correlation data storage unit 53d.

Note that in a case where a part or all of the machine learning device 6 is incorporated into the arithmetic processing device 5, each of the first H₂ correlation data storage unit 52c and the second H₂ correlation data storage unit 52d may be constituted by each of the first H₂ correlation data storage unit 623a and the second H₂ correlation data storage unit 623b of the machine learning device 6, or each of the first O₂ correlation data storage unit 53c and the second O₂ correlation data storage unit 53d may be constituted by each of the first O₂ correlation data storage unit 624a and the second O₂ correlation data storage unit 624b of the machine learning device 6.

### Modification of Modified Embodiment 1

In the Modified Embodiment 1, instead of the individual component concentration included in the training data, an arithmetic value of the specific component concentration calculated from the individual component concentration and the element balance formula may be used. Specifically, first correlation data indicating a minimum error value obtained by minimizing an error between the reference value of the specific component concentration and the arithmetic value of the specific component concentration may be included in the training data. In this case, an information processing device (not illustrated) that generates first correlation data is provided separately from the arithmetic processing device 5, and the arithmetic processing device 5 includes a second correlation data generation unit that performs machine learning on a relationship between the spectrum data and the minimum error value and generates second correlation data of the minimum error value with respect to the spectrum.

### Modification of First Embodiment

For example, as illustrated in FIG. 6, the training data reception unit 61 may receive, as the training data, the individual component concentration obtained from the spectrum data and selected based on the element balance formula, in addition to the reference value of the H₂ concentration, the reference value of the O₂ concentration, and the spectrum data. Then, in the machine learning unit 62, the H₂ correlation data generation unit 621 performs machine learning on the relationship between the reference value of the H₂ concentration, and the spectrum data and the individual component concentration, and generates H₂ correlation data (machine learning model for H₂ concentration calculation) indicating the correlation between the H₂ concentration, and the spectrum data and the individual component concentration. Furthermore, the O₂ correlation data generation unit 622 performs machine learning on the relationship between the reference value of the O₂ concentration, and the spectrum data and the individual component concentration, and generates O₂ correlation data (machine learning model for O₂ concentration calculation) indicating the correlation between the O₂ concentration, and the spectrum data and the individual component concentration. In this way, by including the individual component concentration selected based on the element balance formula in addition to the spectrum data in the training data, the measurement accuracy of the O₂ concentration or the H₂ concentration can be improved.

### Modified Embodiment 2

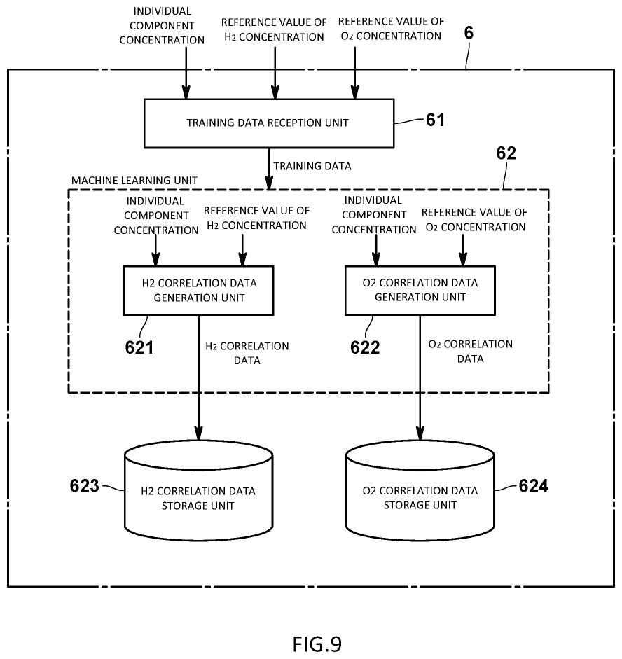

Furthermore, as illustrated in FIG. 9, the training data reception unit 61 receives training data including a reference value of the H₂ concentration obtained by an H₂ analyzer different from the infrared gas analyzer (exhaust gas analysis device), a reference value of the O₂ concentration obtained by an O₂ analyzer different from the infrared gas analyzer (exhaust gas analysis device), and an individual component concentration obtained by the infrared gas analyzer (exhaust gas analysis device). The individual component concentration included in the training data is, for example, an individual component concentration of CO, CO₂, NO, H₂O, NO₂, a hydrocarbon component (HC), or the like analyzed by the individual component analysis unit 512.

The machine learning unit 62 includes an H₂ correlation data generation unit 621 that performs machine learning on a relationship between the reference value of the H₂ concentration and an arithmetic value (estimated value) of the H₂ concentration to generate H₂ correlation data, and an O₂ correlation data generation unit 622 that performs machine learning on a relationship between the reference value of the O₂ concentration and an arithmetic value (estimated value) of the O₂ concentration to generate O₂ correlation data.

Here, the arithmetic value (estimated value) of the H₂ concentration and the arithmetic value (estimated value) of the O₂ concentration can be estimated using the element balance formula obtained from the fuel combustion formula described above. That is, the fact that the H₂ concentration can be linearly regressed by the concentrations of the components (CO₂, CO, H₂O, THC) and the O₂ concentration can be linearly regressed by the concentrations of the components (CO₂, CO, H₂O, THC, NO) from the element balance formula (conservation law of substance amount) is used. Here, in the linear regression formula of the H₂ concentration, the measurement accuracy of the H₂ concentration can be improved by adding an NO concentration in addition to the concentrations of the components (CO₂, CO, H₂O, THC).

The H₂ correlation data (machine learning model for H₂ concentration calculation) generated by the H₂ correlation data generation unit 621 is stored in the H₂ correlation data storage unit 623, and the O₂ correlation data (machine learning model for O₂ concentration calculation) generated by the O₂ correlation data generation unit 622 is stored in the O₂ correlation data storage unit 624.

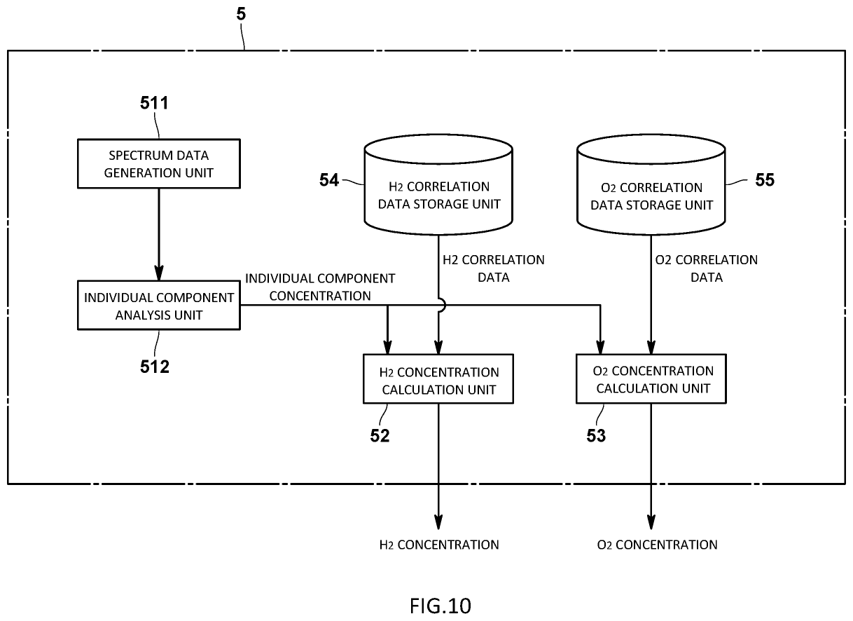

Then, as illustrated in FIG. 10, the exhaust gas analysis device 100 can calculate the H₂ concentration using the H₂ correlation data (machine learning model for H₂ concentration calculation) generated by the machine learning device 6, and can calculate the O₂ concentration using the O₂ correlation data (machine learning model for O₂ concentration calculation).

Specifically, the arithmetic processing device 5 of the exhaust gas analysis device 100 includes the H₂ concentration calculation unit 52 that calculates the H₂ concentration in the combustion exhaust gas from the individual component concentration and the H₂ correlation data, and the O₂ concentration calculation unit 53 that calculates the O₂ concentration in the combustion exhaust gas from the individual component concentration and the O₂ correlation data.

Note that in a case where a part or all of the machine learning device 6 is incorporated into the arithmetic processing device 5, the H₂ correlation data storage unit 54 may be configured from the H₂ correlation data storage unit 623 of the machine learning device 6, or the O₂ correlation data storage unit 55 may be configured from the O₂ correlation data storage unit 624 of the machine learning device 6.

Here, the H₂ concentration calculation unit calculates an arithmetic value of the H₂ concentration from the individual component concentration, and calculates the H₂ concentration in the combustion exhaust gas from the arithmetic value and the H₂ correlation data. Furthermore, the O₂ concentration calculation unit calculates an arithmetic value of the O₂ concentration from the individual component concentration, and calculates the O₂ concentration in the combustion exhaust gas from the arithmetic value and the O₂ correlation data.

It is conceivable to use a THC concentration obtained by a THC analysis device different from an infrared gas analyzer (exhaust gas analysis device) as the THC concentration used in the element balance formula.

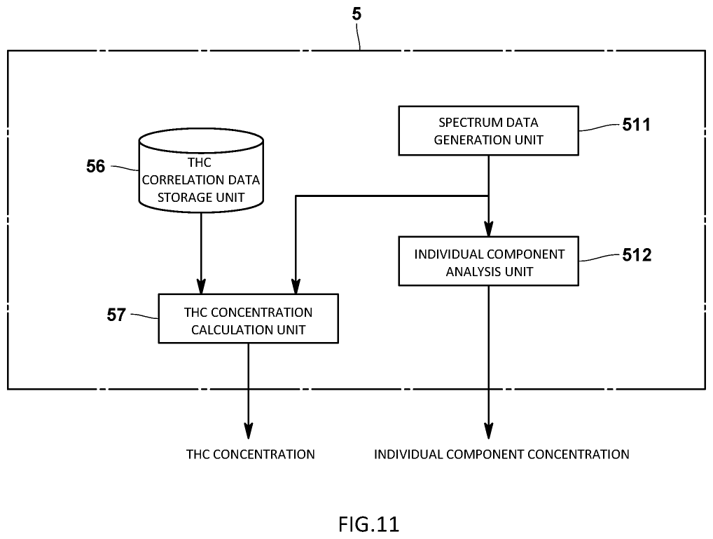

Furthermore, as illustrated in FIG. 11, the exhaust gas analysis device 100 may further include a THC correlation data storage unit 56 that stores THC correlation data obtained by learning a relationship between a reference value of the THC concentration and the spectrum data, and a THC concentration calculation unit 57 that calculates the THC concentration in the combustion exhaust gas from the spectrum data obtained by the infrared gas analyzer (spectrum data generation unit 511) and the THC correlation data, and the THC concentration obtained by the THC concentration calculation unit 57 may be used.

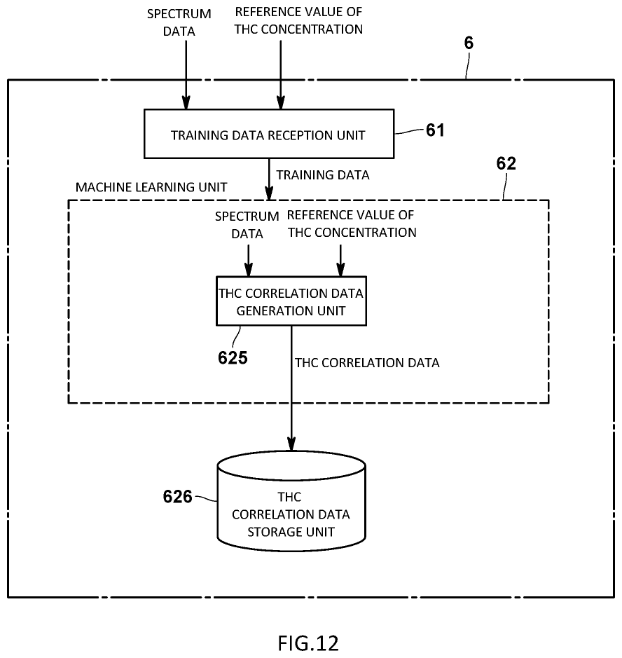

Moreover, as illustrated in FIG. 12, in the machine learning device 6, the training data reception unit 61 may receive training data including a reference value of the THC concentration obtained by a THC analyzer different from an infrared gas analyzer (exhaust gas analysis device) and the spectrum data, and the machine learning unit 62 may include a THC correlation data generation unit 625 that performs machine learning on a relationship between the reference value of the THC concentration and the spectrum data to generate THC correlation data. The THC correlation data generated by the THC correlation data generation unit 625 is stored in a THC correlation data storage unit 626.

The individual component concentrations used in the Modified Embodiments 1 and 2 may be concentrations of all components of CO₂, CO, H₂O, THC, and NO, or may be concentrations of some components of CO₂, CO, H₂O, THC, and NO.

Furthermore, in addition to the machine learning using the arithmetic value of the specific component concentration calculated from the element balance formula, the relationship between the individual component concentration and the specific component concentration may be configured to be machine-learned without obtaining the arithmetic value of the specific component concentration.

In addition, in the Modified Embodiment 1, the first H₂ correlation data generation unit 621a or the second H₂ correlation data generation unit 621b may be configured to calculate the correlation data using the individual component concentration and/or the reference value of the O₂ concentration in addition to the arithmetic value of the H₂ concentration obtained from the individual component concentration. Furthermore, the first O₂ correlation data generation unit 622a or the second O₂ correlation data generation unit 622b may be configured to calculate the correlation data using the individual component concentration and/or the reference value of the H₂ concentration in addition to the arithmetic value of the O₂ concentration obtained from the individual component concentration. By increasing the parameters for machine learning in this manner, the measurement accuracy of the H₂ concentration or the O₂ concentration can be improved.

Moreover, the exhaust gas measurement system of the above embodiment tests the completed vehicle V using the chassis dynamometer 300. However, for example, the exhaust gas measurement system may test the performance of an engine using an engine dynamometer, or may test the performance of a power train using a dynamometer.

The exhaust gas analysis device 100 may be any device as long as it irradiates a measurement sample with light and analyzes the spectrum. As the exhaust gas analysis device 100, in addition to the Fourier transform infrared spectroscopy, for example, NDIR, quantum cascade laser infrared spectroscopy, a non-dispersive infrared absorption method, a chemiluminescence method, or a method obtained by combining these methods may be used. Furthermore, the present invention is not limited to the analysis of the exhaust gas of the automobile, and can also analyze the exhaust gas discharged from an internal combustion engine such as a ship, an aircraft, an agricultural machine, and a machine tool, a power plant, or an incinerator. Furthermore, not only a tail pipe of an internal combustion engine or a flue of a power plant or the like but also a component of exhaust gas contained in the environment may be analyzed. Furthermore, the exhaust gas analysis device may use light other than infrared light.

In addition, various modifications and combinations of the embodiments may be made without departing from the gist of the present invention.

### INDUSTRIAL APPLICABILITY

According to the present invention described above, it is possible to measure the H₂ concentration or the O₂ concentration that needs to be measured using another analyzer in the analysis device.

### REFERENCE SIGNS LIST

100 exhaust gas analysis device
1 infrared light source
4 photodetector
arithmetic processing device
52 H₂ concentration calculation unit
52a H₂ concentration error calculation unit
52b H₂ concentration calculation unit
52c first H₂ correlation data storage unit
52d second H₂ correlation data storage unit
53 O₂ concentration calculation unit
53a O₂ concentration error calculation unit
53b O₂ concentration calculation unit
53c first O₂ correlation data storage unit
53d second O₂ correlation data storage unit
54 H₂ correlation data storage unit
55 O₂ correlation data storage unit
56 THC correlation data storage unit
57 THC concentration calculation unit
6 machine learning device
61 training data reception unit
62 machine learning unit
621 H₂ correlation data generation unit
622 O₂ correlation data generation unit
623 H₂ correlation data storage unit
624 O₂ correlation data storage unit
621a first H₂ correlation data generation unit
621b second H₂ correlation data generation unit
622a first O₂ correlation data generation unit
622b second O₂ correlation data generation unit
623a first H₂ correlation data storage unit
623b second H₂ correlation data storage unit
624a first O₂ correlation data storage unit
624b second O₂ correlation data storage unit
625 THC correlation data generation unit
626 THC correlation data storage unit

1. A machine learning device used in an exhaust gas analysis device that irradiates a combustion exhaust gas with light, performs a detection of light transmitted through the combustion exhaust gas, and analyzes the combustion exhaust gas based on a detection signal of the detection, the machine learning device comprising:
a training data reception unit that receives training data; and
a machine learning unit that performs machine learning using the training data, wherein
the training data reception unit receives training data including:
a reference value of a specific component concentration that is at least one of an H₂ concentration or an O₂ concentration obtained by an analyzer different from the exhaust gas analysis device; and
at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, and
the machine learning unit performs machine learning on a relationship between
a reference value of the specific component concentration, and
at least one of the spectrum data, the individual component concentration, or the arithmetic value of the specific component concentration
to generate specific component correlation data.

2. The machine learning device according to claim 1, wherein
the training data reception unit receives training data including the reference value of the specific component concentration and the spectrum data, and
the machine learning unit performs machine learning on a relationship between the reference value of the specific component concentration and the spectrum data to generate the specific component correlation data.

3. The machine learning device according to claim 2, wherein
the training data reception unit further receives the individual component concentration as training data, and
the machine learning unit performs machine learning on a relationship among the reference value of the specific component concentration, the spectrum data, and the individual component concentration to generate the specific component correlation data.

4. The machine learning device according to claim 1, wherein
the machine learning unit includes:
a first correlation data generation unit that calculates a minimum error value obtained by minimizing an error between the reference value of the specific component concentration and the arithmetic value of the specific component concentration, and generates, as a part of the specific component correlation data, first correlation data indicating a correlation between the minimum error value and a parameter used to calculate the minimum error value; and
a second correlation data generation unit that performs machine learning on a relationship between the spectrum data and the minimum error value to generate, as a part of the specific component correlation data, second correlation data indicating a correlation between the spectrum data and the minimum error value.

5. The machine learning device according to claim 1, wherein
the training data reception unit receives training data including the reference value of the specific component concentration and the individual component concentration, and
the machine learning unit performs machine learning on a relationship between the reference value of the specific component concentration and the individual component concentration to generate the specific component correlation data.

6. The machine learning device according to claim 1, wherein
in a case where machine learning is performed on H₂ correlation data as the specific component correlation data, the individual component concentration is at least one of a CO₂ concentration, a CO concentration, an H₂O concentration, or a THC concentration, and
in a case where machine learning is performed on O₂ correlation data as the specific component correlation data, the individual component concentration is at least one of a CO₂ concentration, a CO concentration, an H₂O concentration, a THC concentration, or an NO concentration.

7. The machine learning device according to claim 1, wherein
the training data reception unit receives training data including a reference value of a THC concentration obtained by an analyzer different from the exhaust gas analysis device and the spectrum data, and
the machine learning unit performs machine learning on a relationship between the reference value of the THC concentration and the spectrum data to generate THC correlation data.

8. The machine learning device according to claim 7, wherein the individual component concentration includes a THC concentration, and the THC concentration is obtained from the spectrum data and the THC correlation data.

9. An exhaust gas analysis device that analyzes combustion exhaust gas, the exhaust gas analysis device comprising:
a light source that irradiates the combustion exhaust gas with light;
a photodetector that detects light transmitted through the combustion exhaust gas;
a specific component correlation data storage unit that stores specific component correlation data generated by the machine learning device according to claim 1; and
a specific component concentration calculation unit that calculates a specific component concentration in the combustion exhaust gas from at least one of the spectrum data, the individual component concentration, or the arithmetic value of the specific component concentration, and the specific component correlation data.

10. The exhaust gas analysis device according to claim 9, wherein the combustion exhaust gas is an exhaust gas of an automobile.

11. The exhaust gas analysis device according to claim 9, wherein Fourier transform infrared spectroscopy is used.

12. A machine learning method used in an exhaust gas analysis device that irradiates a combustion exhaust gas with light, performs a detection of light transmitted through the combustion exhaust gas, and analyzes the combustion exhaust gas based on a detection signal of the detection, the machine learning method comprising:
a training data reception step of receiving training data; and
a machine learning step of performing machine learning using the training data, wherein
the training data reception step receives training data including:
a reference value of a specific component concentration that is at least one of an H₂ concentration or an O₂ concentration obtained by an analyzer different from the exhaust gas analysis device; and
at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, and
the machine learning step performs machine learning on a relationship between
a reference value of the specific component concentration, and
at least one of the spectrum data, the individual component concentration, or the arithmetic value of the specific component concentration
to generate specific component correlation data.

13. A machine learning program used in an exhaust gas analysis device that irradiates a combustion exhaust gas with light, performs a detection of light transmitted through the combustion exhaust gas, and analyzes the combustion exhaust gas based on a detection signal of the detection, the machine learning program causing a computer to have:
a function as a training data reception unit that receives training data; and
a function as a machine learning unit that performs machine learning using the training data, wherein
the training data reception unit receives training data including:
a reference value of a specific component concentration that is at least one of an H₂ concentration or an O₂ concentration obtained by an analyzer different from the exhaust gas analysis device; and
at least one of spectrum data obtained by irradiating the combustion exhaust gas with light, or an individual component concentration selected based on an element balance formula for determining the specific component concentration, or an arithmetic value of a specific component concentration calculated using the individual component concentration in the element balance formula, and
the machine learning unit performs machine learning on a relationship between
a reference value of the specific component concentration, and
at least one of the spectrum data, the individual component concentration, or the arithmetic value of the specific component concentration
to generate specific component correlation data.

14. An exhaust gas analysis method of analyzing a combustion exhaust gas using a light source that irradiates the combustion exhaust gas with light and a photodetector that detects light transmitted through the combustion exhaust gas, the exhaust gas analysis method comprising, by using specific component correlation data generated by the machine learning device according to claim 1, calculating a specific component concentration in the combustion exhaust gas from at least one of the spectrum data, the individual component concentration, or the arithmetic value of the specific component concentration, and the specific component correlation data.

15. An exhaust gas analysis program used in an exhaust gas analysis device using a light source that irradiates combustion exhaust gas with light and a photodetector that detects light transmitted through the combustion exhaust gas, the exhaust gas analysis program causing a computer to have:
a function as a specific component correlation data storage unit that stores specific component correlation data generated by the machine learning device according to claim 1; and
a function as a specific component concentration calculation unit that calculates a specific component concentration in the combustion exhaust gas from at least one of the spectrum data, the individual component concentration, or the arithmetic value of the specific component concentration, and the specific component correlation data.
